(19) United States
(12) Patent Application Publication
(10) Pub. No.: US 2021/0366247 A1
(43) Pub. Date: Nov. 25, 2021

(54) REMOTE CONTAINER ALERT SYSTEM

(71) Applicant: C.H.& I. Technologies, Inc., Santa Paula, CA (US)

(72) Inventors: Lawrence M. Levenstein, Santa Paula, CA (US); Eric A. Williams, Ojai, CA (US); Alejandro C. Arciniega, Ventura, CA (US)

(21) Appl. No.: 17/056,210

(22) PCT Filed: Jul. 24, 2019
(86) PCT No.: PCT/US19/43262

§ 371 Date: Nov. 17, 2020

Related U.S. Application Data
(60) Provisional application No. 62/711,313, filed on Jul. 27, 2018.

(51) Int. Cl. G08B 5/36; G08B 21/18

(52) U.S. Cl. CPC G08B 5/36; G08B 21/182

(57) ABSTRACT

A remote alert and illumination system is disclosed that visually annunciates using tell-tale indicator-lights that certain local discrete status indications (e.g., “OK”, “low-level”, “low-low level”, “fault”) of a remote container's contents for a container that dispenses fluid, and which system initiates certain local responses to these indications accordingly (e.g., “continue to monitor”, “replace fluid/material container”, and “call for help”). The container's processor and a remote data processor use bi-directional (two-way) functionality and separate sources of electrical power to perform these operations. The use of separate sources of electrical power eliminates a fault created by a power outage where the system is reset or defaults to an original status, and local processors latch or retain a last status to avoid errors due to power outages and the like.

### CROSS-REFERENCE TO RELATED APPLICATION

This application is based on and claims the benefit of priority from the prior Patent Application No. PCT/US2019/43262, filed on Jul. 29, 2019, which claims priority from U.S. Ser. No. 62/711,313, filed Jul. 27, 2018, the entire contents of which are incorporated herein by reference.

### BACKGROUND

Large industrial manufacturing and processing facilities often use high volume containers of liquids in the operation of such facilities, such as paints, greases, oils, and the like. In many cases, these containers must be manually attended to for refilling, status updates, maintenance, and other servicing. These service runs are typically performed by minimally trained technicians who are simply trained for performing the service and not much else. The technicians may not be as focused as the facility operator would prefer, and errors are common in the form of serving the wrong containers or performing the incorrect service. Where the monitoring of these containers and machinery is remote, it makes it even more challenging to quickly and unmistakably identify the container to be serviced and the proper service to be performed. The present invention is directed to improving this system and providing a remote monitoring system that illuminates the specific machine to be serviced through a remote alert system, clearly identifying to the technician which service is to be performed on which machine. The result is that servicing can take place quicker (no unnecessary searching) and more efficiently with fewer errors and lost production.

### SUMMARY OF THE INVENTION

The present invention is a remote alert and illumination system that visually annunciates using tell-tale indicator-lights that certain local discrete status indications (e.g., “OK”, “low-level”, “low-low level”, “fault”) of a remote container's contents for a container that dispenses fluid, and which initiates certain local responses to these indications accordingly (e.g., “continue to monitor”, “replace fluid/material container”, and “call for help”). The container's processor and a remote data processor use bi-directional (two-way) functionality and separate sources of electrical power to perform this function. The use of separate sources of electrical power eliminates a fault created by a power outage or loss of signal where the system is reset or defaults to an original status.

The local container's processor outputs electronic data and transmits this data through wireless (WiFi, cellular, Bluetooth, satellite) and/or wired (network/Ethernet, landline) communication systems to the remote data processor. The remote data processor (including hardware and software) remotely monitors, and receives data input (container contents data, fault data) from the local container's processor. The remote data processor processes this data from all connected containers based on programmable logic (settings), and the remote data processor then outputs data in the form of certain local discrete status indications (“OK”, “low-level”, “low-low level”, “fault”) and transmits this data through wireless and/or wired communication systems to the local container's processor.

The local container's processor receives this data input, including the local discrete status indications from the remote data processor, and the local container's processor processes this data. The local container's processor stores this data in its memory, and the local container's processor outputs the discrete status indication(s) to one or more strategically placed indicator lights. The local container's processor also monitors for the presence of a transmission signal with this data input, and the local container's processor is programmed with certain logic in the following manner:

A) If the signal with the data input is present, then the local container's processor stores this data in its memory, where memory administration is FIFO (First In First Out) and the oldest stored data may be overwritten with the newest data, and the local container's processor outputs the discrete status indication(s) to the indicator light(s);

B) If the signal with the data input is not present, then the local container's processor retrieves the last/newest data from its memory, and the local container's processor outputs the discrete status indication(s) to the indicator light(s) based on this last/newest data, and effectively maintains (i.e., “latches”) the last/newest discrete status indication(s). Also if this signal is NOT present, the local container's processor outputs a “fault” indication to an indicator light; and

C) If the signal with the data was not present, but now the signal with the data is present again, then the local container's processor may return a warning indicator light(s) to remote control by the remote data processor, the local container's processor may clear the fault indication if appropriate, and the local container's processor may effectively release (i.e., “unlatch”) the previously maintained (latched) discrete status indication(s) from its memory.

The present invention provides improved efficiency by distinctly and visibly communicating the status via indicator light(s) of a local container so that a technician can instantly recognize the container for servicing. In those not-uncommon applications with multiple containers at a single facility, these indicator lights eliminate the possibility of a human error of responding to the wrong container and the consequential damages (like a costly manufacturing equipment shutdown) from the loss of the availability of a fluid/material to be dispensed to a host process (like lubricants vital to manufacturing equipment). Moreover, the system annunciates the discrete status indications at the local container, available to any human within the line-of-sight of these indications. This broader availability of these indications to more than one human eliminates the possibility of a single-point failure from a non-response from a single human and the consequential damages from the loss of the availability of a fluid/material to be dispensed to a host process. Further, the present invention maintains, or latches, the discrete status indication(s) at the local container. This “latching” functionality eliminates an instantaneous loss of the recent status indication (like “flying blind”) at a local container, based on the loss of signal and/or loss of power associated with the wireless and/or wired communication systems and/or the remote data processor.

These and other features of the present invention may best be understood with reference to the detailed description of the preferred embodiments, along with the associated figures, the description of which are provided below.

### BRIEF DESCRIPTION OF THE DRAWINGS

FIG. 1 is an illustration of a container that may be used with the present invention; and

FIG. 2 is a process diagram for the various components of the present invention.

### DETAILED DESCRIPTION OF THE PREFERRED EMBODIMENTS

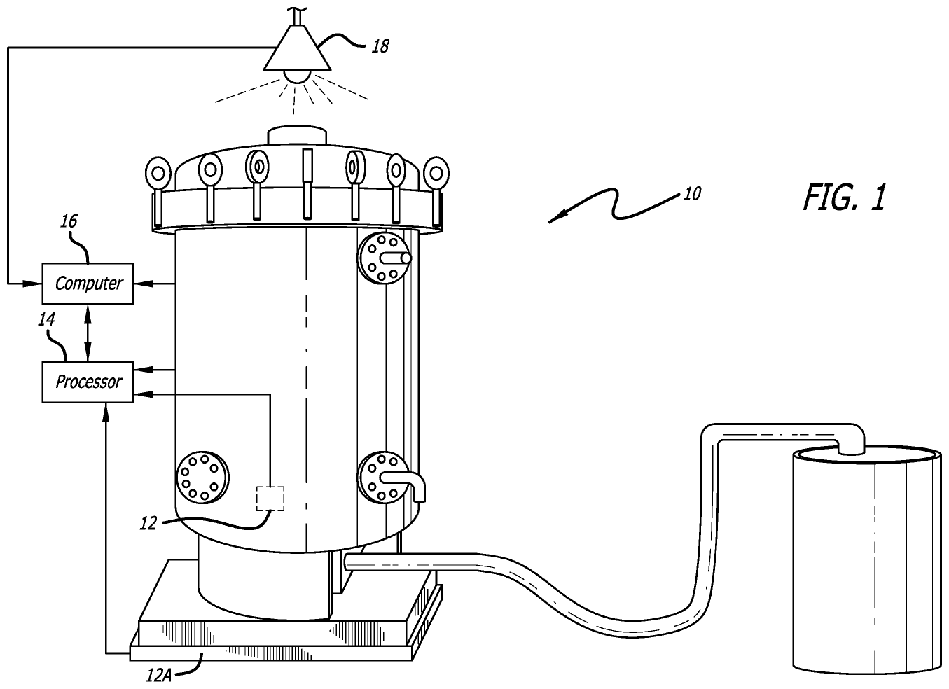

FIG. 1 illustrates a large container 10 used for dispensing a viscous material such as grease that can be used in a manufacturing process. The container 10 is equipped with two-way communication that is used to exchange data with a remote supervising computer. The container is equipped with sensors 12 (e.g., float gauges or weight scales) that determine the quantity of fluid in the container, as well as other possible conditions such as temperature, pressure, mass flow, etc. In the example of FIG. 1, a scale 12A placed under the container can measure the weight of the material in the container, where the scale is electronically linked to a processor 14 associated with the container. These conditions can be relayed to the remote supervising computer 16 for evaluation. The container is also equipped with one or more illumination devices 18 that are prominently positioned for optimal discovery at a distance from the container (such as on top of the container). The illumination devices 18 are controlled in part by the remote supervising computer 16 based on the data provided by the container 10. The container 10 uses a processor 14 to receive input from the sensors 12 and send periodic or real time data to the supervising computer 16 based on conditions in the container 10.

Other complex computer human interfaces such as mobile devices, computer screens, touch screens, and instrumentation panels exist. However, these other complex human interfaces can distract their users, which in turn could lead to a non-response with resultant damages (like a costly manufacturing equipment shutdown). For this invention, it is important that the alert mode for the status indication be a clear, unambiguous signal free from distraction, prominently visible and available to all individuals within a line-of-sight of the visual alert. A highly visible warning light 18 exactly fits this bill. The type of light 18 that can be used with the present invention is varied, including stack lights, strobe beacons, modem lights, LED lights, and the like.

This remotely controlled and programmable system maintains, or “latches”, the discrete status indication(s) at the local device. This “latching” functionality eliminates an instantaneous loss of the recent status indication at the local device, based on the loss of signal and/or loss of power associated with the wireless and/or wired communication systems and/or the remote data processor. This feature improves reliability and preserves the status in the event of a power outage or signal loss.

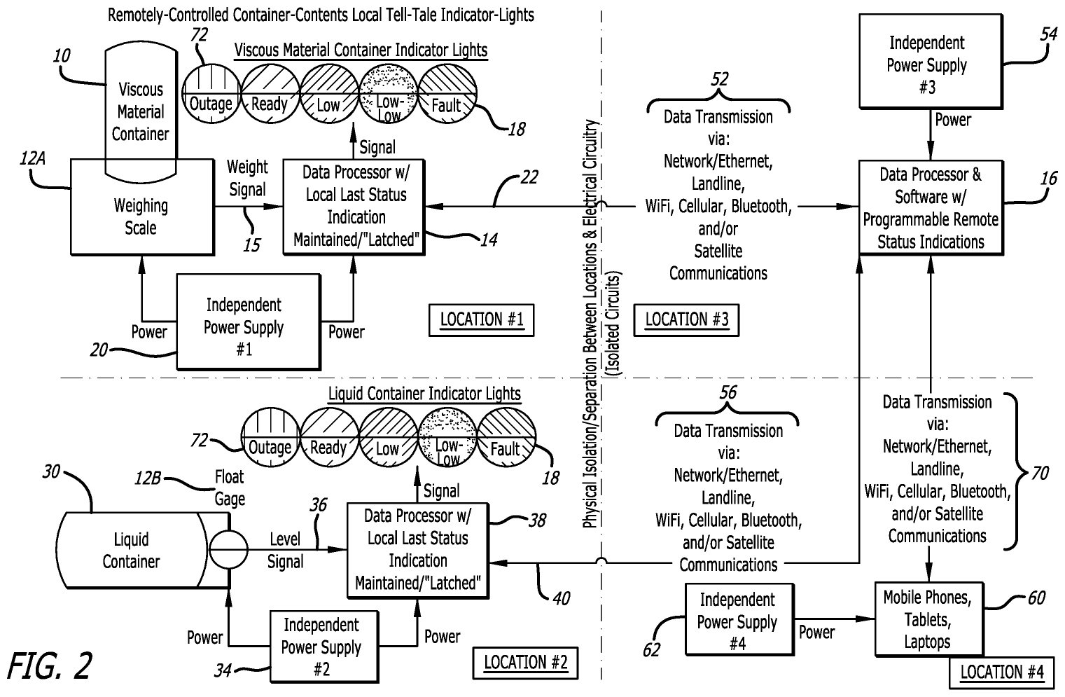

FIG. 2 illustrates a flow chart for the transfer of information between elements of the system of the present invention. With reference to FIG. 2, a viscous material container 10 sits on a weighing scale 12A that is supplied independent power via independent power supply 20. The weighing scale 12A provides data as to the quantity of material in the material container 10, and sends a signal 15 to a local processor 14 associated with the material container 10. The processor 14 is also supplied power by the independent power supply 20, all of which are located locally at location one. The processor 14 generates a signal 22 based on the data supplied by the scale 12A, and forwards the signal 22 to remote supervising computer 16 running a remote monitoring management software. Proximate the viscous material container 10 are lights 18 that are labeled or otherwise designated as statuses for the container 10, for example, “Ready,” “Low,” “Low Low,” and “Fault.” At a second location, a liquid container 30 with a float gage 12B, independent power supply 34 generates a signal 36 from data generated by the float gage 12B and received by a data processor 38, for generating a signal 40 that is also communicated to remote supervising computer 16. As with the viscous material container 10, liquid container 30 includes proximate lights 18 having the same designations as that above.

As indicated above, remote to the first location is a supervising computer 16 at a third location that is connected to the local processor 14 via a two way communication link 52, which may be wired or wireless, including a satellite connection. The supervising computer 16 is connected to an independent power supply 54 that is physically and electrically separated from independent power supplies 20, 34. Similarly, local data processor 38 is connected to the remote supervising computer 16 via the two way communication link 56, which may be the same or different from communication link 52. Examples of wireless data communication links include WiFi, Cellular, Bluetooth, and satellite networks.

As shown in FIG. 2, a portable data processor 60 can also be introduced into the system. Processor 60 is connected to independent power supply 62, and communicates with the supervising computer 16 through a wired or wireless link 70. In this manner, the portable processor 60 can also be used to monitor the status of container 10 and container 30 from a location remote to the first three locations.

The role of the supervising computer 16 is to monitor the quantity of material in the various containers 10, 30 and send status signals through the links 52, 56 that cause the lights 18 to illuminate. Having the status controlled by the supervising computer 16 allows for a single processor running the remote monitoring management software to control the status indicators of all the subject fluid control systems. A single software update or program change will satisfy all the containers, simplifying management of the overall system. However, where the local processors 14, 38 fail to receive a status signal from the supervising processor 16, as might occur in a power outage at the third location where the supervising processor is physically located, the respective local processor 14, 38 retains in memory the last status of the associated container, and continues to illuminate the lights 18 with the last status signal from the supervising computer 16, and causes an additional warning light 72 or other alert to illuminate/actuate (signaling a loss of signal from the supervising processor 16). This latching/memory function, where the last known status of the container is maintained in the event of a failure or power outage, improves reliability where a loss of signal might otherwise lead to non-service of the system. This feature allows for the system to prevent a major malfunction where the system resets or otherwise loses the status of a container for reasons of a power outage or loss of signal.

The present invention has been generally described and depicted to illustrate the inventors' preferred embodiment, but the scope of the invention is intended to extend beyond the descriptions and depictions herein. A person of ordinary skill in the art will readily appreciate many modifications, substitutions, and alterations to the above described embodiments, and the scope of the invention is intended to include all such modifications, substitutions, and alterations. Accordingly, unless expressly so limited, no description of the present invention above is intended to be limiting or exclusive of the variations described in this paragraph.

What is claimed is:

1. A fluid container monitoring system, comprising:
a first container for dispensing a viscous fluid, the first container having a sensor for evaluating a property of the viscous fluid, a local processor, and a two way communication device for transmitting data generated by the sensor;
a first power supply connected to the first container;
a remote supervisor computer having a two way communication device adapted to exchange information with the local processor of the first container, the remote supervisor computer having a second, independent power supply and the remote supervisor computer monitoring a status of the property of the viscous fluid;
an illumination device controlled by the remote supervisor computer in proximity with, but spaced from, the first container, the illumination device adapted to convey the status of the property of the viscous fluid; and
wherein the first container retains in a memory the most recent status from the supervisor computer and can control the illumination device to convey the most recent status when communication is lost between the container and the supervisor computer.

2. The fluid container monitoring system of claim 1, wherein the sensor is a scale measuring a weight of the viscous fluid in the container.

3. The fluid container monitoring system of claim 1, wherein the sensor is float gauge for measuring a volume of the viscous fluid in the container.

4. The fluid container monitoring system of claim 1, wherein the sensor is a thermocouple for measuring a temperature of the viscous fluid in the container.

5. The fluid container monitoring system of claim 1, wherein the sensor is a pressure sensor for measuring a pressure of the viscous fluid in the container.

6. The fluid container monitoring system of claim 1, wherein the sensor is a mass flow sensor for measuring mass flow into and out of the container.

7. The fluid container monitoring system of claim 1, wherein the two way communication devices exchange data wirelessly.

8. The fluid container monitoring system of claim 1, wherein the two way communication devices exchange data using a wired connection.

9. The fluid container monitoring system of claim 1, further comprising a data processor proximate the remote supervisor computer and communicating with the supervisor computer via a second two way communications link.

10. The fluid container monitoring system of claim 1, further comprising a second container for dispensing a viscous fluid, the second container having a sensor for evaluating a property of the viscous fluid in the second container, a processor, and a two way communication device for transmitting data generated by the sensor; and an illumination device controlled by the remote supervisor computer in proximity with, but spaced from, the second container, the illumination device adapted to convey the status of the property of the viscous fluid in the second container.

11. The fluid container monitoring system of claim 1, further comprising a second type of illumination device connected to the local processor, the local processor illuminating the second type of illumination device when communication is lost between the local processor and the remote supervisor computer.
